(19) United States
(12) Patent Application Publication
(10) Pub. No.: US 2021/0289916 A1
(43) Pub. Date: Sep. 23, 2021

(54) MAKEUP APPLICATOR TOOL AND METHODS OF MAKING AND USING SAME

(71) Applicant: Super Sponge Technologies DMCC, Dubai (AE)

(72) Inventors: Ena VEHABOVIC, Dubai (AE); Jhordan Arius STEVENSON, Dubai (AE)

(21) Appl. No.: 17/258,870

(22) PCT Filed: Jul. 12, 2019
(86) PCT No.: PCT/CA2019/050963

§ 371 Date: Jan. 8, 2021

Related U.S. Application Data
(60) Provisional application No. 62/697,363, filed on Jul. 12, 2018.

(51) Int. Cl. A45D 33/34; C08J 9/36; C09D 183/04; B05D 7/02; B05D 3/02; B05D 1/18; A45D 34/04; A45D 40/26

(52) U.S. Cl. CPC A45D 33/34; C08J 9/365; C09D 183/04; B05D 7/02; B05D 3/0254; A45D 2200/1009; A45D 34/04; A45D 40/26; C08J 2375/04; C08J 2483/04; B05D 1/18

(57) ABSTRACT

A makeup blending sponge. The sponge comprises a foam core and a layer of coating. The layer of coating covers a portion of an outer surface of the foam core. The portion may be about 70% to about 90% of the total surface area of the outer surface of the foam core. The foam core may be polyurethane. The layer of coating is an elastomer, and may be a mixture of an elastomer and a thinning agent. The elastomer may be silicone. A method of manufacturing the makeup blending sponge and the use thereof are also disclosed.

### RELATED APPLICATION INFORMATION

This application claims priority to, and the benefit of, U.S. provisional patent application No. 62/697,363 filed 12 Jul. 2018, the entirety of which is incorporated by reference herein for all purposes.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### TECHNICAL FIELD

Some embodiments of the present invention relate to a makeup applicator tool. Some embodiments of the present invention relate to a makeup blending sponge and methods of making and using same.

### BACKGROUND

Traditional makeup applicator tools include, for example, foam sponges and brushes. Foam sponges have the advantage of being able to create an “airbrushed finish”, i.e., giving the skin surface a smooth, natural and flawless finish upon makeup application. However, foam sponges and brushes excessively absorb makeup compositions and thus undesirably create product waste. Foam sponges and brushes also harbour germs and bacteria but are difficult to clean, which means these tools must be replaced often.

Silicone makeup applicators have several advantages. Due to the strength and durability of silicone, they allow for efficient application of makeup. They are easy to clean. In addition, silicone makeup applicators do not absorb excessive amounts of makeup compositions. However, silicone makeup applicators have their disadvantages. They are relatively rigid which makes the applicator too stiff and hard on the skin. Therefore, they do not provide a homogenous and consistent distribution of makeup. Instead, they spread makeup around the skin surface creating streaks and unevenness and leave smears on the skin surface. They also do not allow makeup to be pressed into the skin like a sponge. Therefore, although silicone makeup applicators present many benefits, they are not able to create an airbrushed finish as with foam sponges.

There is a desire for makeup applicators that are soft on the skin, durable, able to provide a homogenous and consistent distribution of makeup, create an airbrushed finish and do not irritate the skin.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

Some embodiments of this invention relate to a makeup blending sponge. The makeup blending sponge has a core made of a foam material and a layer of coating. The layer of coating covers a coated portion of an outer surface of the core. The coated portion is less than about 90% of a total surface area of the outer surface. The layer of coating may be an elastomer. In some embodiments, the coating portion is in a range between about 70% to about 90% of the total surface area of the outer surface. In some embodiments, the coated portion is the total surface area of the outer surface.

In some embodiments, the foam material is polyurethane. In some embodiments, the foam material is a sugar-based polymer, a sugar-based polyurethane or a sea sponge.

In some embodiments, the layer of coating is elastomer. The layer of coating may also include a thinning agent. The thinning agent may be an alcohol, a low viscosity silicone solvent, a silicone oil, an oil, a glycerin, or any mixture thereof. The alcohol may be isopropyl alcohol.

In some embodiments, the layer of coating is prepared from a coating solution. The coating solution includes the elastomer having a concentration of about 80% (w/v) and the thinning agent having a concentration of about 20% (w/v). The layer of coating may have an average thickness of about 0.5 mm to about 5 mm.

In some embodiments, the makeup blending sponge has spaced-apart opposing longitudinally-extending first and second walls and a third wall connecting the first and second walls to define a cavity within the core. The cavity may be sized and dimensioned to allow a portion of the finger to insert therein.

Some embodiments of this invention relate to a method of manufacturing a makeup blending sponge. The method includes the steps of preparing a core with a foam material, preparing a coating solution having a polymer, dipping at least a portion of the core into the coating solution and curing the coated core.

In some embodiments, the portion of the core is dipped into the coating solution for about 1 second to about 10 seconds, or about 4 seconds to about 10 seconds.

In some embodiments, the coated core is cured by heat, radiation, ultraviolet radiation, electron beams, chemical additives or any combination thereof. In some embodiments, the coated core is cured by exposing the coated core to a temperature of about 90° C. to 100° C. for about three hours.

In some embodiments, the method includes forming the core into a configuration.

In some embodiments, the method further includes immersing the cured coated core in distilled water for about 1 second to about 10 seconds. The method may also include drying the cured coated core after the immersing step.

In some embodiments, the method optionally includes slicing the core into two or more portions after the dipping step.

Some embodiments of this invention relate to using the makeup blending sponge for applying a makeup composition on a body surface of a mammalian subject.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1A is a cross-sectional view of a makeup blending sponge according to an example embodiment. FIG. 1B is a front view of a portion of the FIG. 1A view sponge after the FIG. 1A makeup blending sponge is sliced along imaginary line A-A. FIG. 1C is a cross-sectional view of a makeup blending sponge according to a further example embodiment.

FIG. 2 is a cross-sectional view of a makeup blending sponge according to another example embodiment.

FIG. 3 is a flow chart showing a method of manufacturing the FIG. 1A, FIG. 1B, FIG. 1C and FIG. 2 makeup blending sponges according to an example embodiment.

FIG. 4 is a flow chart illustrating a method of using a makeup blending sponge according to an example embodiment.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

As used herein, the term “polymers” means any synthetic and natural polymers. A polymeric foam may be derived from the polymerization of one species of monomer or from the polymerization of more than one species of monomer into copolymers. Polymers include polymer blends, e.g., having two or more polymers blended together. Polymers also include homopolymers, linear and branched polymer structures, crosslinked polymers, copolymers (which may or may not be crosslinked), block copolymers, alternating copolymers, random copolymers, and the like. Oligomers are polymers having a molecular weight below about 1000 Da. In some embodiments, oligomers can be used as the polymer.

As used herein, the term “polyurethane” means a polymer composed of organic units joined by carbamate (urethane) links. Polyurethane polymers are generally formed by the reaction of a di- or tri-polyisocyanate with a polyol. Polyisocyanates and polyols used to make polyurethanes contain, on average, two or more functional groups per molecule. Polyurethanes are used in the manufacture of high-resilience foam seating, rigid foam insulation panels, microcellular foam seals and gaskets, durable elastomeric wheels and tires, high performance adhesives, surface coatings and surface sealants, synthetic fibers, and hard plastic parts.

As used herein, the term “polyurethane foam or sponge” means a sponge prepared by the reaction of a polyisocyanate with a polyol in the presence of a blowing agent, a surfactant, and a catalyst. For flexible urethane foams, the blowing agent is water. Polyurethane foams can be classified into flexible and rigid foams. Flexible foams are further subdivided into flexible and semi-flexible (or semi-rigid) foams, depending on the molecular weight and functionality of the polyols, and the type and functionality of the isocyanate.

As used herein, the term “elastomer” means any natural or synthetic polymer having elastic properties.

As used herein, the term “silicones” or “polysiloxanes” or “organopolysiloxanes” means any organosilicon polymer or oligomer of linear or cyclic, branched or crosslinked structure, of variable molecular weight, obtained by polymerization and/or polycondensation of suitably functionalized silanes. Silicone is constituted of a repetition of main units in which the silicon atoms are linked together via oxygen atoms (siloxane bond), optionally substituted hydrocarbon-based radicals being directly attached to said silicon atoms via a carbon atom. Silicone also encompasses the silanes required for their preparation, in particular alkylsilanes.

As used herein, the term “thinning agent” means any reactive or non-reactive fluid that can lower the viscosity of a compound or mixture.

As used herein, the term “polyisocyanate” means any compound containing multiple isocyanate functional groups. “Isocynanate” is a functional group having a general formula R—N═C═O where R is any alkyl group, N is a nitrogen, C is a carbon and 0 is an oxygen.

As used herein, the term “polyhydroxy” means any compound containing more than one hydroxyl group in a molecule. “Hydroxyl” is a functional group having a general formula—OH where O is an oxygen and H is a hydrogen.

As used herein, the term “curing” means any suitable process which involves cross-linking one polymer chain to another.

As used herein, the term “latex” means a natural rubber made from plant sources such as the sap of the Brazilian rubber tree. Latex is used in numerous medical products, including adhesive bandages, condoms, medical gloves, catheters, sanitary napkins, crutches and blood-pressure monitoring cuffs. Exposure can result in sensitivity to natural rubber latex proteins, with symptoms ranging from skin redness, rash, hives or itching to difficulty breathing and wheezing. Rarely, shock and even death can occur.

As used herein, the term “plasticizers” means a material that, when added to a polymer, imparts an increase in flexibility, workability, and other properties to the finished product.

As used herein, the term “oil” means any fatty substance that is in liquid form at room temperature (25° C.) and at atmospheric pressure (760 mmHg). An oily phase in a cosmetic composition may comprise at least one polar or apolar hydrocarbon-based or silicone oil, or a mixture thereof.

As used herein, the term “silicone oil” is an oil comprising at least one silicon atom, and in particular at least one Si—O group.

As used herein, the term “about” means +/−20% variation of the value it describes.

An aspect of this invention relates to a makeup blending sponge. The sponge may have a three-dimensional shape. The sponge includes a core made of a foam and a layer of coating. The foam may be made from a polymer. The layer of coating covers a portion of the outer surface of the foam polymer. The layer of coating may be made of an elastomer. The portion may be about 70% to about 90% of the total surface area of the outer surface of the foam polymer. About 10% to about 30% of the total surface area of the outer surface of the foam polymer may remain uncoated.

An aspect of the invention relates to a polyurethane sponge that is partially coated with silicone on the outer surface thereof. The silicone coating protects the polyurethane sponge from germs and absorption of cosmetics. Since only a portion of the polyurethane sponge is coated with silicone, the polyurethane sponge retains the squishiness and softness features of a foam sponge. Specifically, the uncoated portion of the foam allows free airflow throughout the sponge. Therefore, the end result upon using the partially silicone coated polyurethane sponge for the makeup application is not a smeared mess (as would have been the result by using a silicone device alone), but an airbrushed finish.

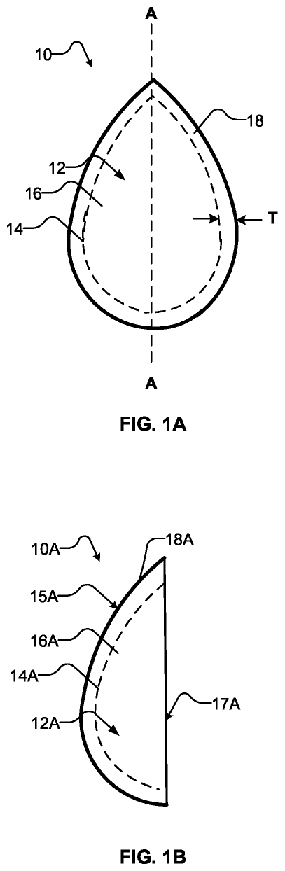

FIG. 1A illustrates a sponge 10 according to an example embodiment. Sponge 10 comprises a core 12. Core 12 includes an outer surface 14. Core 12 may be made of a foam material 16. In some embodiments, foam material 16 is made of a natural sponge material. Natural sponge material may be a plant fibre sponge or an animal fibre sponge. The plant fibre sponge may be any plant that belongs in the genus Luffa. The animal fibre sponge may be a sea sponge. The sea sponge may be any suitable organism that belongs in the phylum Porifera. Foam material 16 may be made of a polymeric foam. Any suitable polymeric foams may be used. Non-limiting examples include polyimide foam, ethylene-vinyl acetate foam, polyethylene foam, nitrile rubber foam, polychloroprene foam, polypropylene foam, polystyrene foam, polyurethane foam, neoprene foam, polyethylene foam, polyvinyl chloride foam, silicone foam and microcellular foam. In an example embodiment, foam material 16 is made of polyurethane. In an example embodiment, foam material 16 is made of poly(beta-methyl-gamma-valerolactone), a sugar-derived polyester compound that can be used to make polyurethane foams, e.g. as described by Schneiderman et al., ACS Macro Letters, 2016, 5(4):515-518, which is incorporated by reference herein in its entirety, or any other similar sugar-based polymer, sugar-based polyurethane, or other polyurethane substitute now known or developed in future. In some embodiments, foam material 16 does not include latex. In some embodiments, foam material 16 includes latex.

Foam material 16 comprises a plurality of pores. The average diameter of the pores may be in a range of between about 10 nanometers (nm) to about 5 millimetres (mm) including any value therebetween e.g., 25 nm, 40 nm, 50 nm, 75 nm, 100 nm, 200 nm, 250 nm, 300 nm, 350 nm, 400 nm, 500 nm, 750 nm, 1 micrometer (μm), 5 μm, 10 μm, 20 μm, 40 μm, 60 μm, 80 μm, 100 μm, 120 μm, 140 μm, 160 μm, 180 μm, 200 μm, 220 μm, 240 μm, 260 μm, 280 μm, 300 μm, 320 μm, 340 μm, 360 μm 380 μm, 400 μm, 450 μm, 500 μm, 550 μm, 600 μm, 650 μm, 700 μm, 750 μm, 800 μm, 850 μm, 900 μm, 950 μm, 1 mm, 2 mm, 3 mm or 4 mm.

In some embodiments, sponge 10 has a layer of coating 18. Coating 18 may be formed from a polymer. The polymer may be an elastomer. Any suitable elastomer may be used. Non-limiting examples include polybutadiene, chloroprene rubber, butyl rubber, nitrile rubber, synthetic polyisoprene, polyacrylic rubber, silicone rubber, polyether block amides and ethylene-vinyl acetate

In some embodiments, coating 18 has a durometer hardness value in a range of between about 1 and about 100 Shore “OO”, including any value or subrange therebetween, e.g., 10 Shore OO, 20 Shore OO, 30 Shore OO, 40 Shore OO, 50 Shore OO, 60 Shore OO, 70 Shore OO, 80 Shore OO or 90 Shore OO; including e.g. less than about 80 Shore OO, less than about 70 Shore OO, less than about 60 Shore OO, or less than about 50 Shore OO. In an example embodiment, coating 18 has a durometer hardness value of about 40 Shore OO.

In some embodiments, coating 18 is formed from an organosilicon compound. In an example embodiment, the organosilicon compound is an organopolysiloxane, or silicone. Non-limiting examples of organopolysiloxanes include methylvinylsiloxanes, methylvinylsiloxane-dimethylsiloxane copolymers, dimethylvinylsiloxy-terminated dimethylpolysiloxanes, dimethylvinylsiloxy-terminated dimethylsiloxane-methylphenylsiloxane copolymers, dimethylvinylsiloxy-terminated dimethylsiloxane-diphenylsiloxane-methylvinylsiloxane copolymers, trimethylsiloxy-terminated dimethylsiloxane-methylvinylsiloxane copolymers, trimethylsiloxy-terminated dimethylsiloxane-methylphenylsiloxane-methylvinylsiloxane copolymers, dimethylvinylsiloxy-terminated methyl(3,3,3-trifluoropropyl) polysiloxane, dimethylvinylsiloxy-terminated dimethylsiloxane-methyl(3,3,-trifluoropropyl)siloxane copolymers, or any mixture thereof.

In some embodiments, the silicone is a platinum-catalyzed silicone, a platinum-cured silicone, a platinum silicone rubber, or any mixture thereof. Non-limiting examples of suitable platinum agents include, but are not limited to, chloroplatinic acids, chloroplatinic acid-olefin complexes, chloroplatinic acid-alkenylsiloxane complexes, chloroplatinic acid-diketone complexes, platinum black, carrier-supported platinum, and any mixture thereof.

In alternative embodiments, any suitable compound can be used to cure the polymer such as silicone, for example organotin compounds, peroxide catalysts, or water. In some embodiments in which a silicone is used that can be cured using ultraviolet light, a catalyst is not added to the silicone during the preparation of coating 18.

In some embodiments, coating 18 is formed from a silicone-like compound. Silicone-like compounds have physical and/or chemical properties similar to silicones. Silicone-like compounds may be a natural compound. The natural compound may be derived from plants. Non-limiting examples include hydrogenated vegetable oils, glyceryl isostearate, caprylic/capric glycerides, sodium stearate, lysophospholipids, xanthan gum, sclerotium gum and pullulan, oils and seeds, disteardimonium hectorite, or any mixtures thereof. Silicone-like compounds may be a polymer. Suitable polymers include ethers or esters. Non-limiting examples include coconut alkanes, polyglyceryl-3 polyricinoleate, propylene glycol dibenzoate, heptyl undecylenate, polyester-4, butylene glycol dicaprylate/dicaprate, silybum marianum ethyl ester or any mixtures thereof.

In some embodiments, the layer of coating 18 has an average thickness T of at least 0.5 mm, including e.g., 1 mm, 2 mm, 3 mm, 4 mm and 5 mm. In some embodiments, the layer of coating 18 has an average thickness T in a range of about 0.5 mm to about 5 mm, including any value therebetween, e.g., 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, 3.1 mm, 3.2 mm, 3.3 mm, 3.4 mm, 3.5 mm, 3.6 mm, 3.7 mm, 3.8 mm, 3.9 mm, 4.0 mm, 4.1 mm, 4.2 mm, 4.3 mm, 4.4 mm, 4.5 mm, 4.6 mm, 4.7 mm, 4.8 mm, 4.9 mm and 5.0 mm.

In some embodiments, coating 18 is prepared from a coating solution. In some embodiments, the coating solution contains a polymer alone. In some embodiments, the coating solution contains a polymer and a thinning agent. Any suitable thinning agent can be used. Non-limiting examples include, but are not limited to, alcohols, ketones, aldehydes, oils, low viscosity silicone solvents, silicone oil, glycerin, and any mixture thereof. Non-limiting examples of suitable oils that can be used as thinning agents include castor oil, flaxseed oil, tea tree oil, olive oil, jojoba oil, retinol, tocopherol, perilla seed oil, eucalyptus oil, rosemary oil, peppermint oil, sweet almond oil, lavender oil, safflower oil, corn oil or any mixture thereof. In some embodiments, the thinning agent is selected to be non-toxic and safe for application to skin.

Any type of alcohol may be used. Non-limiting examples of suitable types of alcohol include isopropyl alcohol, ethyl alcohol, butyl alcohol, methanol and the like. In some embodiments, a ketone such as acetone is used as the thinning agent. In some embodiments, an aldehyde such as acetaldehyde or formaldehyde is used as the thinning agent.

In some examples, the silicone oil includes, but is not limited to, an octamethyltetrasiloxane, a decamethylcyclopentasiloxane, a dodecamethylcyclohexasiloxane, a heptamethyloctyltrisiloxane, a hexamethyldisiloxane, a decamethyltetrasiloxane, a dodecamethylpentasiloxane and any mixtures thereof. Without being bound to any theory, the inventors believe that the addition of a thinning agent to the polymer in some embodiments may enhance absorption of the polymer on outer surface 14 of core 12. This results in a homogenous and durable layer of coating on outer surface 14 of core 12, advantageously allows sponge 10 to glide smoothly on skin surfaces and prevents undesirable friction and a pulling effect on the skin.

In some embodiments, the coating solution comprises a polymer having a concentration in the range from about 0.1% (weight per volume or “w/v”) to about 90% (w/v), including any value therebetween, e.g., 1%, 5%, 10%, 15%, 20%, 25%, 30%, 35%, 40%, 45%, 50%, 55%, 60%, 65%, 70%, 75%, 80% and 85%. In some embodiments, the coating solution comprises a thinning agent having a concentration in the range from about 0.001% (w/v) to about 60% (w/v), including any value therebetween, e.g., 0.01%, 0.1%, 0.5%, 1%, 5%, 10%, 15%, 20%, 25%, 30%, 35%, 40%, 45%, 50%, and 55%. In some embodiments, the coating solution comprises a polymer having a concentration of about 80% (w/v) and a thinning agent having a concentration of about 20% (w/v). In some embodiments, the coating solution comprises equal parts of the polymer and the thinning agent, e.g., 50% (w/v) of polymer and 50% (w/v) of thinning agent.

In some embodiments, the coating solution optionally includes one or more additives. Non-limiting examples of additives include, but are not limited to, bacteriostats, anti-viral agents, fungistats, emollients, plasticizers, keratolytic agents, permeation enhancers, antioxidants, antipruritic agents, anti-acne agents, antibiotic agents, antifungal agents, pigments, perfume, emulsifiers, lubricants, preservatives, stabilizers, wetting agents, emulsifiers, salts, e.g., for influencing osmotic pressure, buffers, colorants, flavorants, and any mixture thereof.

Non-limiting examples of plasticizers include, for example, glycerol, sorbitol, polyethylene glycol, polypropylene glycol, polyethylene-propylene glycol, or a combination thereof.

Non-limiting examples of keratolytic agents include, but are not limited to, urea, lactic acid, allantoin, benzoyl peroxide, salicyclic acid, or a combination thereof.

Non-limiting examples of permeation enhancers include glycerol monolaurate (GML), lecithin, or a vegetable oil, for example, safflower oil, cottonseed oil and corn oil.

Non-limiting examples of antioxidants include, but are not limited to, ascorbic acid (vitamin C) and its salts, ascorbyl esters of fatty acids, ascorbic acid derivatives (e.g., magnesium ascorbyl phosphate, sodium ascorbyl phosphate, ascorbyl sorbate), tocopherol (vitamin E), tocopherol sorbate, tocopherol acetate, other esters of tocopherol, butylated hydroxy benzoic acids and their salts, bioflavonoids, curcumin, lysine, methionine, proline, superoxide dismutase, silymarin, tea extracts, grape extracts, melanin, and rosemary extracts. In some embodiments, the antioxidant may be present at a concentration from 0.1% to 10% w/w of the sponge, including any value therebetween e.g. 0.5%, 1%, 2%, 3%, 4%, 5%, 6%, 7%, 8%, and 9% w/w.

In some embodiments, as illustrated in FIG. 1A, the layer of coating 18 covers substantially the entire surface of outer surface 14 (e.g., the layer of coating 18 covers 100% of the total surface area of outer surface 14). In some embodiments, the layer of coating 18 covers a portion of outer surface 14. In such embodiments, the layer of coating 18 covers more than about 50% of the total surface area of outer surface 14, e.g., 55%, 60%, 65%, 70%, 75%, 80%, 85%, 90%, 95% and 99% of the total surface area. In some embodiments, the layer of coating 18 covers about 70% to about 90% of the total surface area of outer surface 14, including any value therebetween, e.g., 72%, 74%, 76%, 78%, 80%, 82%, 84%, 86% and 88% of the total surface area. In such embodiments, about 10% to about 30% of the total surface area of outer surface 14 is not covered with coating 16, including any value therebetween e.g. 12%, 14%, 16%, 18%, 20%, 22%, 24%, 26% or 28%. In an example embodiment, the layer of coating 18 covers about 90% of the total surface area of outer surface 14.

In some embodiments, partial coating of outer surface 14 is achieved by only applying coating 18 to a portion of outer surface 14. In some embodiments, partial coating of outer surface 14 is achieved by dipping sponge 10 into a coating solution and only partially submerging sponge 10. FIG. 1C shows an example embodiment of a sponge 10C in which coating 18C has been applied only to a portion of sponge 10C, for example as could be achieved by dipping core 12 only partially into a coating solution. The thickness T of coating 18C is shown in an exaggerated fashion relative to the dimensions of core 12 for clearness of illustration only and is not shown to scale.

In an example embodiment, core 12 is made of a foam material such as polyurethane and the layer of coating 18 comprises a silicone rubber. Foam materials such as polyurethane and silicone or silicone-like compounds have distinct advantages in the field of make-up application. For example, foam materials allow makeup to be pressed into the skin surface and spread homogenously on the skin surface to create an “airbrush finish”. Foam materials are not durable and are hard to clean. Silicone or silicone-like compounds are durable, easy to clean and do not irritate the skin but are relatively rigid which can be too hard and stiff for the skin. The inventors have discovered that partial coating of elastomers such as silicone or silicone-like compounds on outer surface 14 of a foam material such as polyurethane core 12 combines the advantages of both of these materials. Without being bound to any theory, the inventors believe that partial coating of elastomers such as silicone or silicone-like compounds on the foam material such as polyurethane core 12 prevents air from being entrapped inside the polyurethane core 12 and thus provides sponge 10 with breathability and flexibility.

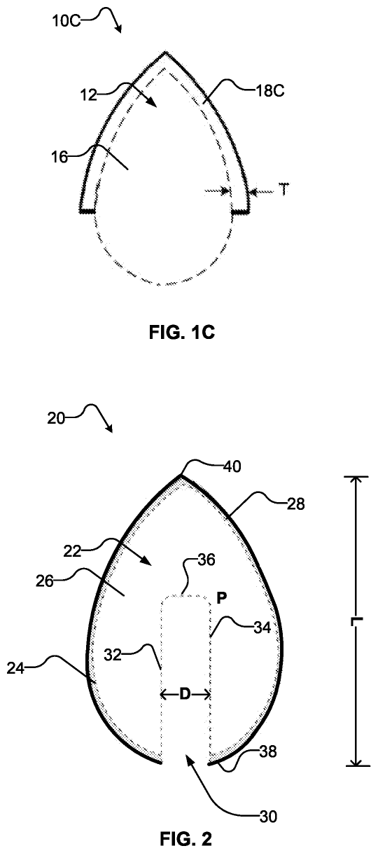

FIG. 2 illustrates a sponge 20 according to another embodiment of the invention. Similar to sponge 10, sponge 20 includes a core 22. Core 22 is made of a foam material 26. Core 22 includes an outer surface 24. Outer surface 24 may be covered with a layer of coating 28. In the FIG. 2 embodiment, longitudinally-extending spaced-apart opposing walls 32, 34 and an upper wall 36 connecting walls 32, 34 define a cavity 30 within core 22. Walls 32, 34 may extend longitudinally upwardly from a first end 38 of sponge 20. In some embodiments, walls 32, 34 extend upwardly to a point P along a longitudinal length L of sponge 20. Length L may extend between first end 38 and a second end 40 of sponge 20. Point P may be at any point along length L. In an example embodiment, point P is at least about ⅓ along length L, e.g., ½ along length L, ⅔ along length L, and ¾ along length L, as measured from first end 38 to second end 40. Cavity 30 may be sized to allow a user's finger to insert therein. For example, a distance D between walls 32, 34 may be about 5 mm to about 40 mm, including any value therebetween, e.g., 10 mm, 15 mm, 20 mm, 25 mm, 30 mm and 35 mm.

Outer surface 24 of core 22 includes walls 32, 34, 36 within cavity 30. In an example embodiment, walls 32, 34, 36 are not coated with coating 28, i.e., the layer of coating 28 does not cover the walls 32, 34, 36 within cavity 30, and sponge 20 is only partially coated with coating 28. A total surface area of cavity 30 is defined by the cumulative surface area of walls 32, 34, 36. In some embodiments, the total surface area of cavity 30 comprises about 10% to about 30% of the total surface area, including e.g., 12%, 14%, 16%, 18%, 20%, 22%, 24%, 26% and 28%, of core 22. The inventors believe that the uncoated walls 32, 34, 36 within cavity 30 allow airflow and create a breathable area within sponge 20 in some embodiments.

In the example embodiments, sponge 10 or 20 has a tear drop configuration. Sponge 10 or 20 may be any suitable three-dimensional shapes. Non-limiting examples of suitable shapes include a ball, an oval, an egg, a square, a triangle, a diamond and a rectangle.

In some embodiments, sponge 10 or 20 may be sliced into one or more portions. Referring to FIG. 1A and 1B, sponge 10 may be sliced along imaginary line A-A to create sponge 10A. Slicing sponge 10 along imaginary line A-A creates two equally-sized portions of sponge 10. This is not mandatory. Sponge 10 may be sliced into any suitable number of portions. Sponge 10A is substantially similar to sponge 10. Sponge 10A includes a core 12A which may be made of a foam material 16A. An outer surface 14A of core 12A includes a layer of coating 18A. As best shown in FIG. 1B, only an unsliced outer surface portion 15A of outer surface 14A includes a layer of coating 18A. The sliced outer surface portion 17A of outer surface 14A does not include a layer of coating 18A. Thus, the sponge 10A of FIG. 1B is only partially coated, having an uncoated outer surface portion 17A and a coated outer surface portion 14A.

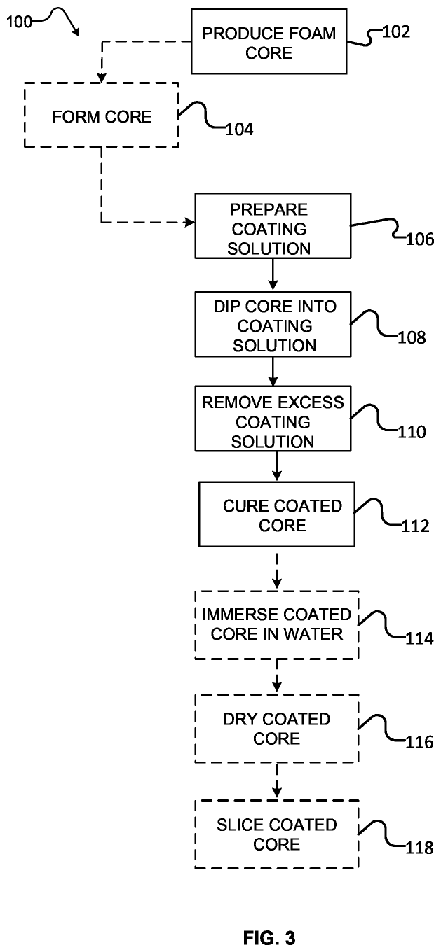

Aspects of this invention relate to methods of making a makeup blending sponge. FIG. 3 is a flow chart illustrating the steps of making a makeup blending sponge according to an example embodiment. Method 100 includes step 102 of preparing a foam core. In some embodiments, the foam core is a polymer foam core. Any suitable method of preparing a polymer foam core can be used. In an example embodiment, the polymer foam core is made of polyurethane. In such embodiment, a polyurethane foam is prepared by a reaction mixture comprising a polyisocyanate, a polyhydroxy compound (polyol), a blowing agent and other conventional additives such as catalysts, surfactants, fillers or non-woven fibers.

Step 104 optionally involves shaping the foam core into a desirable shape. In some embodiments, the foam core is molded to a desired shape. Any suitable molding method can be used, including but not limited to, open cast molding, compression molding, centrifugal molding and injection molding. A hole may optionally be created in the mold so that a cavity is provided within the foam core as shown in the FIG. 2 embodiment. In some embodiments, the foam core is provided with a desirable shape from a bulk starting material by cutting, shaving, grinding, lathing, boring, or any other suitable shaping technique.

Step 106 involves preparing a coating solution. The coating solution preparation step 104 may be performed before or after the foam core production step 102 or the shaping step 104. As discussed above, the coating solution includes a polymer and optionally includes a thinning agent. In an example embodiment, the polymer is an elastomer such as a silicone rubber. The silicone rubber may be prepared by any suitable methods, for example, by curing, vulcanizing or catalyzing. In some embodiments, the silicone rubber is catalyzed or cured with one or more platinum agents. Non-limiting examples of suitable platinum agents include, but are not limited to, chloroplatinic acids, chloroplatinic acid-olefin complexes, chloroplatinic acid-alkenylsiloxane complexes, chloroplatinic acid-diketone complexes, platinum black, carrier-supported platinum, and any mixture thereof. In an example embodiment, the thinning agent is a low viscosity silicone solvent, an alcohol a ketone, an aldehyde, an oil, a silicone oil, glycerin, or the like. Non-limiting examples of suitable oils that can be used as thinning agents include castor oil, flaxseed oil, tea tree oil, olive oil, jojoba oil, retinol, tocopherol, perilla seed oil, eucalyptus oil, rosemary oil, peppermint oil, sweet almond oil, lavender oil, safflower oil, corn oil or any mixture thereof. In one example embodiment, the thinning agent is isopropyl alcohol. The suitable thinning agent is preferably hypoallergenic, allergy free, non-toxic and safe for use on the skin.

In some embodiments, the coating solution comprises a two-component silicone elastomer having a Part A and a Part B, e.g. Dow SYLGARD™, Mold Star™, or the like. In some embodiments, the two-component silicone elastomer is a room temperature or heat-curing silicone. In some embodiments, a catalyst such as tin or platinum is added to Part A to adjust the composition to have a curing time within a desired range. In some embodiments, the catalyst is a platinum complex containing vinyl-siloxane ligand. An example is the silicone-soluble Karstedt' s catalyst. The silicone-soluble Karstedt's catalyst may be used in the presence of two inhibitors, e.g., dimethyl fumarate and dimethyl maleate, to extend reaction life.

Step 108 involves dipping the foam core into the coating solution to create a layer of coating on the outer surface of the foam core. The coating penetrates the outer surface of the foam core and adheres to the pores of the foam core. In some embodiments, the foam core is dipped in the coating solution for about one second to about one minute, including any value therebetween, e.g., 20 s., 40 s., 60 s., or 1 min. In some embodiments, the foam core is dipped in the coating solution for about one second to about 30 seconds, including any value therebetween, e.g., 1 s., 5 s., 10 s., 15 s., 20 s. or 25 s. In some embodiments, the foam core is dipped in the coating solution for about one second to about five seconds, including any value therebetween, e.g., 1 s., 2 s., 3 s., 4 s. or 5 s. In some embodiments, the foam core is dipped in the coating solution for about one second to about two seconds. In some embodiments, the foam core is dipped in the coating solution for about four seconds to about five seconds. The inventors have determined that the dipping of the foam core in the coating solution for a short duration, e.g., about 1 s. to about 5 s., creates a layer of coating with a thickness of about 0.5 mm to about 5 mm, including e.g., 1.0 mm, 1.53 mm, 2.0 mm, 2.5 mm, 3.0 mm, 3.5 mm, 4.0 mm and 4.5 mm around the outer surface of the foam core.

In some embodiments, dipping of the foam core involves submerging a portion of the foam core into the coating solution, e.g., a portion of the outer surface of the foam core remains uncoated, i.e. the foam core is only partially coated. For example, the user may hold onto a bottom portion of the foam core (e.g., about 10% to about 30% of the foam core) and expose only a top portion of the foam core (e.g., about 70% to about 90% of the foam core) to the coating solution. The bottom portion of the foam core will not contact the coating solution. In such embodiments, about 70% to about 90% of the outer surface of the foam core, including e.g., 75%, 80% and 85% of the outer surface, is dipped into the coating solution. Thus, about 10% to about 30% of the outer surface of the foam core, including e.g., 15%, 20% and 25% of the outer surface, remains uncoated. In another example, the bottom portion of the foam core may be temporarily covered, e.g., by an adhesive. The foam core may be fully dipped into the coating solution. The outer surface of the top portion of the foam core will thus be coated while the outer surface of the bottom portion (which is protected by the adhesive) remains uncoated. The adhesive may be subsequently removed to expose the uncoated portion of the foam core.

Step 110 involves draining the coated foam core to remove excess coating solution. Step 112 involves curing the coated foam core. The curing step physically adheres the coating solution onto the foam core. Curing can be initiated by any suitable process such as heat, radiation, including ultraviolet radiation, electron beams and chemical additives. In an example embodiment, curing is induced by heat. For example, curing may be performed by exposing the coated foam core to a temperature in a range of between 20° C. and 120° C., including e.g., 25° C., 30° C., 35° C., 40° C., 45° C., 50° C., 55° C., 60° C., 65° C., 70° C., 75° C., 80° C., 85° C., 90° C., 95° C., 100° C., 105° C., 110° C. and 115° C. for a time period of between about 30 minutes to about six hours (h), including any value therebetween e.g., 1 h, 1.5 h, 2 h, 2.5 h, 3 h, 3.5 h, 4.0 h, 4.5 h, 5.0 h and 5.5 h. In an example embodiment, curing of the coated foam core is performed at 25° C. for about three hours. In another example embodiment, curing of the coated foam cure is performed at about 90° C. to about 100° C. for about three hours. The length of the curing time may be shortened or extended by varying the temperature and/or the physical and/or chemical properties of the coating solution.

In an example embodiment, the coating solution includes a two-component silicone elastomer having a Part A and a Part B, e.g. Dow SYLGARD™, Mold Star™, or the like. The two-component silicone elastomer may be a room temperature or heat-curing silicone. In some embodiments, a catalyst such as tin or platinum is added to Part A to adjust the composition to have a curing time within a desired range. In some embodiments, the catalyst is a platinum complex containing vinyl-siloxane ligand. An example is the silicone-soluble Karstedt's catalyst. The silicone-soluble Karstedt's catalyst may be used in the presence of two inhibitors, e.g., dimethyl fumarate and dimethyl maleate, to extend reaction life.

Method 100 optionally includes step 114 of immersing the cured coated core in distilled water. The cured coated core may be immersed in distilled water for a short duration, for example, about 1 second to about 10 seconds, including e.g., 2 s., 3 s., 4 s., 5 s., 6 s., 7 s., 8 s. and 9 s. Step 116 provides for drying the water-immersed cured coated core. The drying may be performed at room temperature. The inventors believe that optional steps 114 and 116 advantageously expand the foam core and add fluffiness to the texture. In some embodiments, step 116 is performed by a consumer prior to using the product and need not be performed as part of method 100.

Method 100 may also optionally include step 118 of slicing through the coated core to create one or more portions as best shown in FIG. 1B. Step 118 may be performed after the curing step 112.

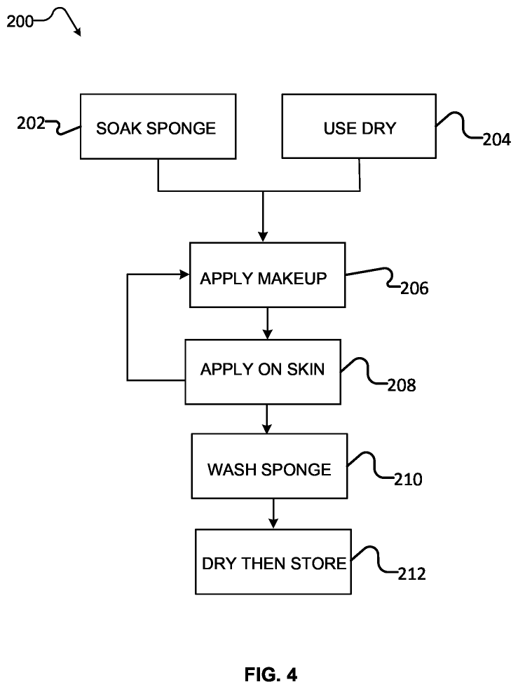

Aspects of this invention relate to a method of using a makeup blending sponge. FIG. 4 is a flow chart illustrating a method 200 of using a makeup blending sponge according to an example embodiment.

Method 200 includes optional step 202 of soaking the sponge with water. Excess water may be drained out by squeezing the sponge. The sponge may also be used substantially dry as shown in step 204.

Step 206 involves bringing the sponge into contact with any suitable cosmetic composition. The cosmetic composition may be powder, liquid solution, emulsion, liquid suspension, cream or gel. In one example embodiment, the cosmetic is foundation. Any part of the sponge may be used to contact with the makeup composition. For example, in the embodiment in which the sponge has a tear drop configuration (e.g., the FIG. 2 embodiment), second end 40 of sponge 20 (i.e., the tip of the sponge) may be brought into contact with the makeup composition. The portion of the sponge with the makeup may then be brought into contact with a body surface of a mammal in step 208. The mammal may be an animal or a human subject. The body surface may include, but is not limited to, a face such as cheeks, forehead, chin and nose, eyes, eyelashes, eyebrows, lips, ears, hair, nails, hands, feet, shoulders, neck, chest, back, arms and legs.

Steps 206 and 208 may be repeated as many times as the user desires. The number of times steps 206 and 208 are repeated depend on the amount of coverage desired by the user.

After the cosmetic has been applied, the sponge may be washed in step 210. The sponge may be washed with warm water and a gentle cleansing soap or liquid, for example. The sponge is then dried, for example, air-dried before storing it away or re-using it as shown in step 212.

### EXAMPLES

Embodiments of the invention are further described with reference to the following examples, which are illustrative and not limiting in nature.

### Example 1.0—Method of Making a Latex-Free Polyurethane Sponge Partially Coated with Silicone

A soft, latex-free polyurethane sponge was prepared by reacting a polyisocyanate with a polyol in the presence of a blowing agent, a surfactant, and a catalyst, and molded into a tear-shaped mold. The sponge thus formed was partially dipped in a silicone bath containing 50% (w/v) ultra-soft, platinum grade silicone (Eco-Flex™ 00-50) and 50% (w/v) thinning agent (NOVOCS™ Gloss) for 1 to 5 seconds to create a thin silicone membrane having a thickness of 1 to 3 mm over 90% of the polyurethane sponge's surface. 10% of the polyurethane sponge's surface was left uncoated to allow airflow and create a breathable area within the sponge. The excess silicone solution was drained off and the resulting latex-free polyurethane sponge partially coated with the silicone coating was cured for 3 hours at room temperature (25° C.). The sponge thus produced was immersed in distilled water for 1-2 seconds, squeezed and dried at room temperature.

In an alternative method, a soft latex-free polyurethane sponge was prepared by reacting a polyisocyanate with a polyol in the presence of a blowing agent, a surfactant, and a catalyst, and molded into a tear-shaped mold. A hole was cored out of the sponge thus formed and a peg was inserted into the hole to block silicone from penetrating the hole. See FIG. 2. The sponge was then dipped in a silicone bath containing 50% (w/v) ultra-soft, platinum grade silicone (Eco-Flex 00-50) and 50% (w/v) thinning agent (NOVOCS™ Gloss) for 1 to 2 seconds. This process created a thin silicone membrane having a thickness of 1 to 3 mm over 90% of the polyurethane sponge's surface. 10% of the polyurethane sponge's surface, corresponding to the hole area covered by the peg, was left uncoated to allow airflow and create a breathable area within the sponge. The excess silicone solution was then drained off the sponge and the resulting latex-free polyurethane sponge partially coated with the silicone coating was cured for 3 hours at room temperature (25° C.). The sponge thus produced was immersed in distilled water for 1-2 seconds, squeezed and dried at room temperature.

### Example 2.0—Method of Applying Makeup with the Disclosed Latex-Free Polyurethane Sponge Partially Coated with Silicone

10 soft and fluffy, latex-free polyurethane sponges partially coated with a silicone coating were prepared as described in Example 1 and distributed to a group of 10 people, including 5 men and 5 women, ages 16 to 92, who had previously used fingers, brushes, sponges and silicone applicators to apply makeup. Each person received instructions to use their new sponge to apply makeup first thing the next day, by dipping the disclosed latex-free polyurethane sponge partially coated with a silicone coating into their favorite makeup composition and applying the makeup composition to their skin, lashes, lips, eye shadow, forehead, hair, nails, hands, feet, shoulders, arms, chest, back, and/or legs, as they liked. Each person was also instructed to convene 5 hours later to report their results.

At the end of the cosmetic trial, each person in the group reported that the disclosed latex-free polyurethane sponge partially coated with a silicone coating was very flexible and easy to squeeze, felt soft to the skin and more comfortable for use as compared to entirely occlusive silicone sponges or other traditional tools used to apply makeup. Three persons with sensitive skin reported no irritation to the skin, rash, redness, inflammation or discoloration of the skin. Two elderly persons commented that they were able to apply makeup with the disclosed sponge in a precise manner and achieve proper makeup contour, a result that they were not able to achieve using conventional makeup application tools. All subjects expressed satisfaction that the soft latex-free polyurethane sponge partially coated with a silicone coating provided herein did not absorb makeup and did not remove makeup.

### Example 3.0—Preparation of a Make-up Sponge Comprising a Polyurethane Foam Partially Coated with Silicone

A polyurethane foam was prepared by reacting a polyisocyanate with a polyol in the presence of a blowing agent, a surfactant, and a catalyst. A silicone bath was prepared. The silicone bath comprises a ratio of about 20% wt./wt. of ispropyl alcohol in silicone (i.e., 20 g of isopropyl alcohol for every 100 g of silicone). The silicone has a durometer hardness value of about 40 Shore 00. The polyurethane foam was then dipped into the silicone bath for about 4 to 10 seconds. Excess silicone solution was drained off for about 60 seconds. The coated polyurethane foam was then cured for about 3 hours at about 90° C. to about 100° C. The cured coated polyurethane foam was then left at room temperature (about 25° C.) for about 24 hours before packaging.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

Without limitation of the foregoing, some embodiments have a number of different aspects, including without limitation:

(A) A latex-free polyurethane sponge for application to a mammal's body surface, wherein the polyurethane sponge is partially coated with a silicone coating, and wherein the sponge is soft, breathable and flexible.

(B) The latex-free polyurethane sponge of aspect (A), wherein 70 to 90% of the polyurethane sponge is coated with the silicone coating.

(C) The latex-free polyurethane sponge of aspect (B), wherein 90% of the polyurethane sponge is coated with the silicone coating.

(D) The latex-free polyurethane sponge of any one of the preceding aspects, wherein the polyurethane sponge comprises an airflow hole that constitutes 10% to 30% of the latex-free polyurethane sponge, and wherein the airflow hole is not coated with the silicone coating.

(E) The latex-free polyurethane sponge of aspect (A), wherein the silicone coating is a thin layer comprising from 0.1% (w/v) to 90% (w/v) of a soft skin-safe silicone and from 0.001% (w/v) to 60% (w/v) of a thinning agent, and wherein the thin layer has a thickness of 1 to 5 mm.

(F) The latex-free polyurethane sponge of aspect (E), wherein the soft skin-safe silicone is one or more of a platinum-catalyzed silicone, a platinum-cured silicone, a platinum silicone rubber, and any mixture thereof.

(G) The latex-free polyurethane sponge of aspect (E), wherein the soft skin-safe silicone is an organopolysiloxane comprising one or more of a methylvinylsiloxane, methylvinylsiloxane-dimethylsiloxane copolymer, a dimethylvinylsiloxy-terminated dimethylpolysiloxane, a dimethylvinylsiloxy-terminated dimethylsiloxane-methylphenylsiloxane copolymer, a dimethylvinylsiloxy-terminated dimethylsiloxane-diphenylsiloxane-methylvinylsiloxane copolymer, a trimethylsiloxy-terminated dimethylsiloxane-methylvinylsiloxane copolymer, a trimethylsiloxy-terminated dimethylsiloxane-methylphenylsiloxane-methylvinylsiloxane copolymer, a dimethylvinylsiloxy-terminated methyl(3,3,3-trifluoropropyl) polysiloxane, a dimethylvinylsiloxy-terminated dimethylsiloxane-methyl(3,3,-trifluoropropyl)siloxane copolymer, and any mixture thereof.

(H) The latex-free polyurethane sponge of aspect (G), wherein the soft skin-safe silicone is catalyzed or cured with one or more of a chloroplatinic acid, a chloroplatinic acid-olefin complex, a chloroplatinic acid-alkenylsiloxane complex, a chloroplatinic acid-diketone complex, platinum black, a carrier-supported platinum, and any mixture thereof.

(I) The latex-free polyurethane sponge of aspect (E), wherein the thinning agent is one or more of a low viscosity silicone solvent, a silicone oil, a glycerin, an alcohol, and any mixture thereof.

(J) The latex-free polyurethane sponge of aspect (I), wherein the silicone oil is one or more of an octamethyltetrasiloxane, a decamethylcyclopentasiloxane, a dodecamethylcyclohexasiloxane, a heptamethyloctyltrisiloxane, a hexamethyldisiloxane, a decamethyltetrasiloxane, a dodecamethylpentasiloxane and mixtures thereof.

(K) The latex-free polyurethane sponge of any one of the preceding aspects, wherein the sponge further comprises one or more of a bacteriostat, a fungistat, an emollient, a plasticizer, a keratolytic agent, a permeation enhancer, an antioxidant, a pigment, a perfume, an emulsifier, a lubricant, a preservative, a stabilizer, a wetting agent, an emulsifier, a salt for influencing osmotic pressure, a buffer, a colorant, a flavorant, and any mixture thereof.

(L) The latex-free polyurethane sponge of any one of the preceding aspects, wherein the sponge has a shape of a ball, an egg, a square, a triangle, a diamond, a rectangle, or a tear.

(M) A method for producing a soft and flexible, latex-free polyurethane sponge that is partially coated with a silicone coating, wherein the method comprises:
a. molding a soft, latex-free polyurethane sponge in a shape of a ball, an egg, a square, a triangle, a diamond, a rectangle, or a tear.
b. mixing a soft, skin-safe silicone solution with a thinning agent to obtain a silicone mixture.
c. dipping 70 to 90% of the soft latex-free polyurethane sponge in the silicone mixture for 1 to 5 seconds to obtain a soft, latex-free polyurethane sponge partially coated with a thin layer of silicone coating.
d. removing excess silicone mixture from the soft, latex-free polyurethane sponge partially coated with the thin layer of silicone coating by draining the sponge. And
e. curing the soft, latex-free polyurethane sponge partially coated with the thin layer of silicone coating.

(N) The method of aspect (M), wherein the method further comprises:
a. wetting the soft latex-free polyurethane sponge partially coated with the thin layer of silicone coating in distilled water for 1 second to 24 hours. And
b. drying the sponge at room temperature.

(O) The method of any one of the preceding aspects, wherein step (c) comprises creating a hole in the soft latex-free polyurethane sponge and inserting a peg into the hole prior to dipping the sponge in the silicone mixture.

(P) The method of any one of the preceding aspects, wherein curing the partially coated soft latex-free polyurethane sponge in step (e) comprises exposing the sponge to a temperature range between 20° C. and 60° C. for a time period between 30 minutes and 6 hours.

(Q) The method of any one of the preceding aspects, wherein the curing is at 25° C. for 3 hours.

(R) The method of any one of the preceding aspects, wherein step (a) comprises molding the soft latex-free polyurethane sponge in the shape of a tear.

(S) The method of any one of the preceding aspects, wherein the thin layer of silicone coating has a thickness of 1 to 5 mm, and wherein the thin layer of silicone coating covers 70% to 90% of the latex-free polyurethane sponge.

(T) The method of any one of the preceding aspects, wherein the silicone mixture comprises from 0.1% (w/v) to 90% (w/v) of a soft skin-safe silicone and from 0.1% (w/v) to 60% (w/v) of a thinning agent.

(U) The method of aspect (T), wherein the soft skin-safe silicone is one or more of a platinum-catalyzed silicone, a platinum-cured silicone, and a platinum silicone rubber.

(V) The method of aspect (T), wherein the soft skin safe silicone is an organopolysiloxane comprising one or more of a methylvinylsiloxane, a methylvinylsiloxane-dimethylsiloxane copolymer, a dimethylvinylsiloxy-terminated dimethylpolysiloxane, a dimethylvinylsiloxy-terminated dimethylsiloxane-methylphenylsiloxane copolymer, a dimethylvinylsiloxy-terminated dimethylsiloxane-diphenylsiloxane-methylvinylsiloxane copolymer, a trimethylsiloxy-terminated dimethylsiloxane-methylvinylsiloxane copolymer, a trimethylsiloxy-terminated dimethylsiloxane-methylphenylsiloxane-methylvinylsiloxane copolymer, a dimethylvinylsiloxy-terminated methyl(3,3,3-trifluoropropyl) polysiloxane, a dimethylvinylsiloxy-terminated dimethylsiloxane-methyl(3,3,-trifluoropropyl)siloxane copolymer, and any mixture thereof.

(W) The method of aspect (T), wherein the soft skin-safe silicone is catalyzed or cured with one or more of a chloroplatinic acid, a chloroplatinic acid-olefin complex, a chloroplatinic acid-alkenylsiloxane complex, a chloroplatinic acid-diketone complex, platinum black, a carrier-supported platinum, and any mixture thereof.

(X) The method of any one of the preceding aspects, wherein the thinning agent is one or more of a low viscosity silicone solvent, a silicone oil, a glycerin, and any mixture thereof.

(Y) The method of aspect (X), wherein the silicone oil is one or more of an octamethyltetrasiloxane, a decamethylcyclopentasiloxane, a dodecamethylcyclohexasiloxane, a heptamethyloctyltrisiloxane, a hexamethyldisiloxane, a decamethyltetrasiloxane, a dodecamethylpentasiloxane and mixtures thereof.

(Z) The method of any one of the preceding aspects, further comprising adding one or more of a bacteriostat, a fungistat, an emollient, a plasticizer, a keratolytic agent, a permeation enhancer, an antioxidant, a pigment, a perfume, an emulsifier, a lubricant, a preservative, a stabilizer, a wetting agent, an emulsifier, a salt for influencing osmotic pressure, a buffer, a colorant, a flavorant, and any mixture thereof to the silicone mixture.

(AA) A method for applying makeup to a mammal's skin, wherein the method comprises dipping a soft and flexible, latex-free polyurethane sponge partially coated with a silicone coating into a makeup composition and applying the makeup composition to the skin.

(BB) The method of claim (AA), wherein the makeup composition is a powder, a liquid solution, an emulsion, a liquid suspension, a cream or a gel.

(CC) The method of any one of the preceding aspects, wherein the makeup composition is applied to the mammal's face, eye shadow, lashes, lips, forehead, nails, hands, feet, shoulders, arms, back, or legs.

(DD) The method of any one of the preceding aspects, wherein the silicone coating comprises from 0.1% (w/v) to 90% (w/v) of a soft skin-safe silicone and from 0.001% (w/v) to 60% (w/v) of a thinning agent.

(EE) The method of any one of the preceding aspects, wherein the silicone coating is a thin layer having a thickness of 1 to 5 mm and covering 70% to 90% of the latex-free polyurethane sponge.

(FF) The method of any one of the preceding aspects, wherein the soft skin-safe silicone is one or more of a platinum-catalyzed silicone, a platinum-cured silicone, and a platinum silicone rubber.

(GG) The method of any one of the preceding aspects, wherein the soft skin-safe silicone is an organopolysiloxane comprising one or more of a methylvinylsiloxane, methylvinylsiloxane-dimethylsiloxane copolymer, a dimethylvinylsiloxy-terminated dimethylpolysiloxane, a dimethylvinylsiloxy-terminated dimethylsiloxane-methylphenylsiloxane copolymer, a dimethylvinylsiloxy-terminated dimethylsiloxane-diphenylsiloxane-methylvinylsiloxane copolymer, a trimethylsiloxy-terminated dimethylsiloxane-methylvinylsiloxane copolymer, a trimethylsiloxy-terminated dimethylsiloxane-methylphenylsiloxane-methylvinylsiloxane copolymer, a dimethylvinylsiloxy-terminated methyl(3,3,3-trifluoropropyl) polysiloxane, a dimethylvinylsiloxy-terminated dimethylsiloxane-methyl(3,3,-trifluoropropyl)siloxane copolymer, and any mixture thereof.

(HH) The method of any one of the preceding aspects, wherein the soft skin-safe silicone is catalyzed or cured with one or more of a chloroplatinic acid, a chloroplatinic acid-olefin complex, a chloroplatinic acid-alkenylsiloxane complex, a chloroplatinic acid-diketone complex, platinum black, a carrier-supported platinum, and any mixture thereof.

(II) The method of any one of the preceding aspects, wherein the thinning agent is one or more of a low viscosity silicone solvent, a silicone oil, a glycerin, and any mixture thereof.

(JJ) The method of any one of the preceding aspects, wherein the silicone oil is one or more of an octamethyltetrasiloxane, a decamethylcyclopentasiloxane, a dodecamethylcyclohexasiloxane, a heptamethyloctyltrisiloxane, a hexamethyldisiloxane, a decamethyltetrasiloxane, a dodecamethylpentasiloxane and mixtures thereof.

(KK) The method of any one of the preceding aspects, wherein the silicone coating further comprises one or more of a bacteriostat, a fungistat, an emollient, a plasticizer, a keratolytic agent, a permeation enhancer, an antioxidant, a pigment, a perfume, an emulsifier, a lubricant, a preservative, a stabilizer, a wetting agent, an emulsifier, a salt for influencing osmotic pressure, a buffer, a colorant, a flavorant, and any mixture thereof.

(LL) The method of any one of the preceding aspects, wherein the sponge has a shape of a ball, an egg, a square, a triangle, a diamond, a rectangle, or a tear.

1. A makeup blending sponge comprising:
a core made of a foam material;
a layer of coating comprising an elastomer, the layer of coating covering a coated portion of an outer surface of the core, wherein the portion comprises in a range between about 50% to about 90% of the total surface area of the outer surface.

2.-4. (canceled)

5. The makeup blending sponge as defined in claim 1 wherein the foam material is polyurethane.

6. The makeup blending sponge as defined in claim 1 wherein the foam material is a sugar-based polymer, a sugar-based polyurethane, and/or a sea sponge.

7. (canceled)

8. The makeup blending sponge as defined in claim 1 wherein the elastomer is silicone.

9. The makeup blending sponge as defined in claim 1 wherein the elastomer has a durometer hardness value in the range of about 20 to about 90 Shore OO.

10. (canceled)

11. The makeup blending sponge as defined in claim 8 wherein the silicone is an organopolysiloxane selected from the group consisting of a methylvinylsiloxane, methylvinylsiloxane-dimethylsiloxane copolymer, a dimethylvinylsiloxy-terminated dimethylpolysiloxane, a dimethylvinylsiloxy-terminated dimethylsiloxane-methylphenylsiloxane copolymer, a dimethylvinylsiloxy-terminated dimethylsiloxane-diphenylsiloxane-methylvinylsiloxane copolymer, a trimethylsiloxy-terminated dimethylsiloxane-methylvinylsiloxane copolymer, a trimethylsiloxy-terminated dimethylsiloxane-methylphenylsiloxane-methylvinylsiloxane copolymer, a dimethylvinylsiloxy-terminated methyl(3,3,3-trifluoropropyl) polysiloxane, a dimethylvinylsiloxy-terminated dimethylsiloxane-methyl(3,3,-trifluoropropyl)siloxane copolymer and any mixture thereof.

12. The makeup blending sponge as defined in claim 1 wherein the layer of coating further comprises a thinning agent.

13. The makeup blending sponge as defined in claim 12 wherein the thinning agent is an alcohol, a low viscosity silicone solvent, a silicone oil, an oil, a glycerin, or any mixture thereof.

14.-15. (canceled)

16. The makeup blending sponge as defined in claim 12, wherein the layer of coating is prepared from a coating solution, the coating solution comprises the elastomer having a concentration in the range from about 0.1% weight per volume (w/v) to about 90% (w/v) and the thinning agent having a concentration in the range from about 0.001% (w/v) to about 60% (w/v).

17. (canceled)

18. The makeup blending sponge as defined in claim 1 wherein the layer of coating has a thickness of about 0.5 mm to about 5 mm.

19. (canceled)

20. The makeup blending sponge as defined in claim 1 further comprising spaced-apart opposing longitudinally-extending first and second walls and a third wall connecting the first and second walls to define a cavity within the core.

21.-23 (canceled)

24. The makeup blending sponge as defined in claim 1 wherein the coating has a durometer hardness value in a range of between about 1 and about 100 Shore OO.

25.-26. (canceled)

27. A method of manufacturing a makeup blending sponge comprising the steps of:
preparing a core comprising a foam material;
preparing a coating solution, the coating solution comprising a polymer;
dipping about 50% to about 90% of the core into the coating solution; and
curing the coated core.

28. A method as defined in claim 27, wherein the step of preparing a coating solution comprises preparing a coating solution comprising a polymer and a thinning agent.

29. The method as defined in claim 27, further comprising forming the core into a configuration.

30. (canceled)

31. The method as defined in claim 27 further comprising creating a cavity within the core before the dipping step.

32.-34. (canceled)

35. The method as defined in claim 27 wherein the coated core is cured by heat, radiation, ultraviolet radiation, electron beams, chemical additives or any combination thereof.

36.-37. (canceled)

38. The method as defined in claim 27 further comprising adding a catalyst to the coating solution.

39. (canceled)

40. The method as defined in claim 27 further comprising immersing the cured coated core in distilled water.

41.-42. (canceled)

43. The method as defined in claim 27 further comprising slicing the core into two or more portions after said dipping step.

44.-46. (canceled)
